(19) United States
(12) Patent Application Publication
(10) Pub. No.: US 2012/0013750 A1
(43) Pub. Date: Jan. 19, 2012

(54) Sound Optimization Via Camera

(75) Inventor: Stefan Heise, Bronshoj (DK)

(73) Assignee: GN Netcom A/S, Ballerup (DK)

(21) Appl. No.: 13/184,973

(22) Filed: Jul. 18, 2011

Related U.S. Application Data
(60) Provisional application No. 61/364,881, filed on Jul. 16, 2010.

(51) Int. Cl. H04N 5/225

(52) U.S. Cl. 348/207.1; 348/E05.024

(57) ABSTRACT

The disclosure relates to a method and system for sound optimization to be installed on a computer, wherein the optimization determines the positions of a microphone and a sound source on a digital image captured by the camera and optimizes how the sound captured by the microphone or advises the user on how optimize by repositioning the microphone and the sound source in relation to each other.

### TECHNICAL FIELD

The invention relates to a sound optimization system for optimizing the sound captured by a microphone.

Microphones for capturing sound from audio sources are used in many different connections. There are many different scenarios where microphones are used to capture sound from sound sources. In most cases it is desirable to capture the sound as efficient as possible, so that an audio signal representing the sound delivered by the sound source as best as possible can be obtained. In order to achieve this, a good positioning of the microphone in relation to the sound source is important.

There are different ways to obtain an optimal or suboptimal position of a microphone in relation to the sound source.

### BACKGROUND

The object of the invention is to provide a new and simple way of positioning a microphone in relation to a sound source in order to optimize the captured sound signal.

The disclosure provides a sound optimization system comprising

a computer with optimization software,

a digital camera connected to the computer,

wherein

the optimization software is adapted to determine the positions of a microphone and a sound source on a digital image captured by the camera and give advice of how the sound captured by the microphone can be optimized by repositioning the microphone and the sound source in relation to each other. The principles used in f. ex. face recognition/detection software can be used for recognizing different sound sources, such as the human mouth or a moving person and a microphone. Off course, there exists many types of microphones, and some of them may be easier to recognize on an image than others.

The software of the sound optimization may comprise a face detection part in order to localize the mouth of a person.

The microphone may be a body worn microphone or a head worn microphone, such as a microphone comprised by a headset.

The headset may comprise a microphone boom, the direction of which is adjustable. Thus the system may inform the user to adjust the boom, so its direction is optimized in relation the mouth.

The microphone could also be comprised by a tele-conferencing device, such as a speakerphone.

According to an embodiment, the optimization software is adapted to determine the positions of more than one sound source. Thus, the system may determine the positions of several persons in a meeting room and propose an optimal position of a microphone, such that it can capture the voices from all the persons.

According to an embodiment, the positions of the microphone and the sound sources can be assisted by user input. This, the user may assist the system by f. ex. tell the system to look after two mouths and a microphone of a specific type.

Such a user assisted system could also be embodied, such that the image captured by the camera is displayed on a computer monitor and wherein the user identifies the positions by means of a pointing device, such as a computer mouse, or by touching the monitor if this is a touch-screen display.

The disclosure also relates to a software program for sound optimization to be installed on a computer, wherein the optimization software is adapted to determine the positions of a microphone and a sound source on a digital image captured by the camera and give advice of how the sound captured by the microphone can be optimized by repositioning the microphone and the sound source in relation to each other.

The disclosure also relates to a method for sound optimization comprising the steps of providing

a computer with optimization software and a connected digital camera, and where the following steps are undertaken:

determination of the positions of a microphone and a sound source on a digital image captured by the camera,

giving advice of how the sound captured by the microphone can be optimized by repositioning the microphone and the sound source in relation to each other.

### BRIEF DESCRIPTION OF THE DRAWINGS

The disclosure is explained in detail below with reference to the drawing illustrating embodiments of the invention and in which

FIG. 1 is a side view of a person with a headset sitting in front of a computer, and

FIG. 2 is an image captured by a camera connected to the computer shown in FIG. 1.

### DETAILED DESCRIPTION

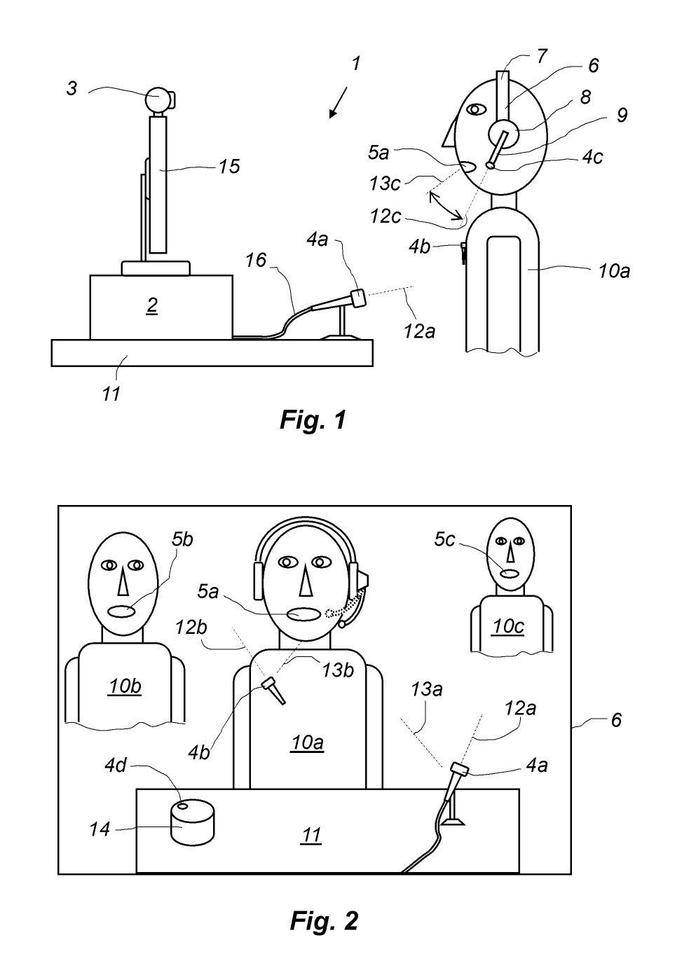

FIG. 1 discloses a first person 10a sitting in front of a computer 2 which stands on a table 11. A monitor 15 and a webcam 3 is connected to the computer 2. Also a desktop microphone 4a pointing in a first direction 12a is connected to the computer 2 by means of a cable 16.

The first person 10a is wearing a headset 6 comprising a headband 7 and two earphones 8. A pivotable microphone boom 9 with a microphone 4c at the free end is extending from the left earphone 8. The microphone boom 9 points in a first direction 12c. The sound source, which the microphone 4c is intended to pick up, is the first person's 10a mouth 5a. In order to pick up the first persons 10a voice most efficiently, the microphone boom 4 should be pivoted to the direction 13c which brings the microphone 4c closer to the mouth 5. The first person 10a is also wearing a small clip-on microphone 4b which is attached on his chest.

The sound optimization system comprises the computer 5, the monitor 15, the webcam 3 and a sound optimization software program installed on the computer 5. The program is able to recognise the first person's 10a face and the position of the mouth 5a. It is also able to recognise the microphones 4a, 4b and 4c. In a real situation a person may not make use of so many microphones 4a, 4b, 4c simultaneously, but they are shown here in order to clarify the scope of the invention. Methods for face recognition are well known and widely used with digital cameras that autofocus on faces. In the same way, a software program can be taught to recognize microphones. However, it may in some situations be difficult as microphones can be designed with an outer shape that looks like other subjects, such as pens, jewelleries, badges and the like. In these situations, the software my pinpoint some objects on the image that could look like a microphone and ask the user to select the microphone from one of them. If none of the selected subjects is a microphone, the user may point at it by means of a mouse cursor, or touch the monitor at the relevant position if it is touch-screen monitor.

FIG. 2 disclose an image 6 captured by the webcam 3. The image discloses the first person 10a and two other persons sitting in the background, namely a second person 10b and a third person 10c. Also a speakerphone 14 with a built-in microphone 4d standing on the table 11 is disclosed. Again not all the microphones 4a, 4b, 4c, 4d and all the persons 10a, 10b, 10c may be present simultaneously but are shown for disclosing the different embodiments of the invention. The optimization system may be helpful in the following scenarios:
a) The first person 10a is using the headset 6 for soft phone conversations. The sound optimization software “sees” that the microphone boom 9 does not point in the direction of the mouth 5 and instructs the first person 10a to move the microphone boom 9 to the position shown with dashed lines in FIG. 2. The instructions can take place by means of text on the screen, voice instructions and/or animations showing what to do.
b) ½ The first person 10a uses the desktop microphone 4a for gaming or telecommunication. The optimization system instructs the first person to turn the microphone 4a form pointing in the first direction 12a to the second and more optimal direction 13a.
c) The first person 10a, the second person 10b and the third person 10c participate in a teleconference by means of the speakerphone 14d. The optimization system recognises all the three persons and their positions in relation to the speakerphone 14. The system proposes to move the speakerphone 14 from the left side to the right side of the table 11, as the third person 11 is positioned furthest from the table.
d) The first person participates in a webinar and uses the clip-on microphone 4b, which is attached on his chest. The system instructs him to turn the microphone 4b from pointing in the direction 12b to the direction 13b.

The microphones 4a, 4b, 4c and 4d need not to be connected to the computer 5, but could be connected to other devices such as a PSTN telephone and a cell phone.

The new and inventive concept of the invention is that it uses picture recognition for sound optimization. However, the picture recognition could be combined with sound measuring in order to optimise the sound further.

The picture recognition technique could also be utilised for adjusting sound processing if the sound is directed via the computer. Thus, the image could disclose that the user is sitting in a noisy environment and actuate noise cancelling processing.

1. A sound optimization system comprising
a computer with optimization software,
a digital camera connected to the computer,
wherein
the optimization software including face detection capability and being adapted to determine the positions of a microphone and a sound source on a digital image captured by the camera and give advice of how the sound captured by the microphone can be optimized by repositioning the microphone and the sound source in relation to each other.

2. A sound optimization system according to claim 1, wherein the sound source is a human mouth.

3. A sound optimization system according to claim 2, further including user actuated identification of the position of a microphone.

4. A sound optimization system according to claim 1, wherein the microphone is body worn microphone or head worn microphone.

5. A sound optimization system according to claim 4, wherein the microphone is comprised by a headset.

6. A sound optimization system according to claim 5, wherein the headset comprises a microphone boom, the direction of which is adjustable.

7. A sound optimization system according to claim 1, wherein the microphone is comprised by a teleconferencing device, such as a speakerphone.

8. A sound optimization system according to claim 7, wherein the optimization software is adapted to determine the positions of more than one sound source.

9. A sound optimization system according to claim 7, wherein the positions of the microphone and the sound sources can be assisted by user input.

10. A sound optimization system according to claim 9, wherein the image captured by the camera is displayed on a computer monitor and wherein the user identifies the positions by means of a pointing device, such as a computer mouse, or by touching the monitor if this is a touch-screen display.

11. A software program for sound optimization to be installed on a computer, wherein the optimization software is adapted to determine the positions of a microphone and a sound source on a digital image captured by a camera and give advice of how the sound captured by the microphone can be optimized by repositioning the microphone and the sound source in relation to each other.

12. Method sound optimization system comprising the steps of providing a computer with optimization software and a connected digital camera, wherein the following steps are undertaken:
determination of the positions of a microphone and a sound source on a digital image captured by the camera,
giving advice of how the sound captured by the microphone can be optimized by repositioning the microphone and the sound source in relation to each other.
